(19) United States
(12) Patent Application Publication
(10) Pub. No.: US 2026/0054700 A1
(43) Pub. Date: Feb. 26, 2026

(54) BRAKE SYSTEM AND METHOD FOR CARRYING OUT A PARKING BRAKE FUNCTION OF A VEHICLE

(71) Applicant: ZF CV Systems Global GmbH, Bern (CH)

(72) Inventor: Julian Van Thiel, Großburgwedel (DE)

(21) Appl. No.: 19/300,866

(22) Filed: Aug. 15, 2025

(30) Foreign Application Priority Data
Aug. 23, 2024 (EP) 24196064.0

(51) Int. Cl. B60T 8/172; B60K 35/28; B60T 7/08; B60T 8/171; B60W 10/184; B60W 10/22; F16D 127/06

(52) U.S. Cl. CPC B60T 8/172; B60K 35/28; B60T 8/171; B60W 10/184; B60W 10/22; B60K 2360/162; B60T 7/08; B60T 2250/00; B60T 2270/402; B60T 2270/406; B60W 2510/18; B60W 2520/00; B60W 2710/188; B60W 2710/22; F16D 2127/06

(57) ABSTRACT

A brake system (10) for carrying out a parking brake function (82) has individually controllable brake actuators (14), a monitoring arrangement (30) that detects a first state (38) or second state (40) of the vehicle, and a brake control device (20) that receives a parking brake request signal (26). The first state is a fault free state and the second state is a faulty state. In the case of the first state (38), the brake control device controls each of the brake actuators respectively with a value (48) predetermined for the respective brake actuator (14) as a target braking force value (22). In the case of the second state (40), the brake control device controls at least one of the brake actuators (14) with a target braking force value (22) that corresponds to a sum (72) of the predetermined value (48) and a compensation value component (70).

### FIELD

The present disclosure relates to the area of brake devices for vehicles, in particular commercial vehicles such as trucks, semi-trailers or agricultural tractors.

### BACKGROUND

Brake systems of vehicles, such as commercial vehicles or passenger cars, are well-known from the prior art. Brake systems of a vehicle usually include one brake cylinder per wheel of the vehicle which, when actuated, for example by a brake pedal, presses one or more brake pads connected to a brake piston against a brake disk of the respective wheel in order to produce a braking action.

A brake cylinder of a brake system is operated with a fluid to provide a service brake function, wherein a pressure in a pressure chamber of the brake cylinder is increased or reduced by using the fluid. The fluid is, for example, a gas, specifically compressed air, or a liquid, specifically a brake fluid or a hydraulic fluid. In particular in commercial vehicles, the brake cylinders are frequently operated by compressed air.

Brake systems with compressed air operation usually have a compressed air reservoir in the form of a compressed air tank, the pressure of which is continuously maintained by a compressor. Depending on a braking request indicated by a brake pedal, service brake valves are then switched. As a result of the switching of the service brake valves, the pressure in the pressure chambers of the brake cylinder is increased, maintained or reduced by using the compressed air from the compressed air reservoir. A brake piston is accordingly displaced in a first direction as a result of increasing the pressure. The brake piston thereby overcomes an opposing force from a spring. If the pressure is reduced, the spring displaces the brake piston in a second direction opposite to the first direction.

A brake system or brake device which exerts a force on the brake disk as a function of a brake pedal position by using the brake pad is designated as a service brake or as a brake system with service brake function and is used for braking during normal travel of the vehicle.

Furthermore, in addition to the service brake function, a parking brake function is also necessary in order to keep a parked vehicle safely in its position even on slopes. The parking brake function of a brake system is also designated as a parking brake or handbrake. Accordingly, the parking brake function can also be designated as a handbrake function. Implementing the handbrake in the aforementioned brake systems which are operated with a fluid is likewise carried out by the spring. If the gas is let completely out of the brake cylinder, then the brake piston is pressed with its brake pad against the brake disk by the spring. Thus, in particular when at a standstill, a vehicle can be kept safely in its position without maintaining a pressure with a compressor.

To implement the brake functions and in particular the parking brake function, electromechanical brake actuators are also increasingly used in vehicle systems. For example, a brake piston of a brake cylinder, in addition to an actuation or an operation with a fluid, can thus also be actuated by an electromechanical brake actuator in order to provide the handbrake function.

One advantage in the use of an electromechanical brake actuator consists for example in the fact that this is just not dependent on fluidic operating mediums, such as compressed air or brake fluid. In the event of a pressure drop in a compressed air operated service brake, emergency braking can thus also be carried out by the electromechanical brake actuator. The additional use of an electromechanical brake actuator to implement a handbrake function thus also creates the precondition for an emergency brake system, which is also designated as an auxiliary brake.

However, the combined use of a brake system with compressed air operation for implementing the service brake and electromechanical brake actuators for implementing a parking brake requires high precision in the control. In particular, desired positions of the electromechanical brake actuator for moving a brake piston or brake cylinder have to be determined very accurately. The precise control is necessary in order, firstly, not to produce any excessive force when pressing a brake pad onto a brake disk, which could lead to damage, and, secondly, to generate an adequate force so that the desired brake action is established. Furthermore, the current position of the brake piston of a brake cylinder which was set by a service brake by way of compressed air also has to be taken into account when an electromechanical actuator for a handbrake is controlled.

Furthermore, brake systems are also known in which a braking function with compressed air operation for implementing the service brake is completely dispensed with and the electromechanical brake actuator also performs the service brake function.

Irrespective of whether use is made in a vehicle of a brake system which implements the service and parking brake exclusively with electromechanical brake actuators or a brake system which has the service brake with compressed air and in addition electromechanical brake actuators for implementing a parking brake function or an auxiliary braking function, as already explained above there are high requirements on the control of electromechanical brake actuators that are used. In particular in the case when a vehicle is parked, the electromechanical brake actuators have to be set such that these have a specific target braking force. It is necessary, for example, to take account of the fact that brake disks and brake pads can cool down, and thus the set braking force can vary when at a standstill. To this end, a target braking force either has to be selected to be so high that an adequate braking force is always available despite any cooling, or the electromechanical brake actuators have to be reset after a certain time period during which a vehicle is stationary. For this purpose, fixed target braking force values are predefined, with which the brake actuators are controlled during a situation in which the vehicle is to be held by a parking brake.

These target braking force values are frequently determined in advance for the vehicle, for example by calculations, such that no excessively high force from the brake pad acts on the brake disk, so that the latter is not damaged but, on the other hand, the vehicle is held securely. Usually, account is taken during the determination of the fact that each of the braked wheels contributes to holding the vehicle.

Now, if one of the electromechanical brake actuators fails, then there is the danger that, at least in specific situations, the previously calculated braking force from the remaining actuators is no longer sufficient to hold the vehicle. Such situations are, for example, when the vehicle is parked on an incline, in particular with a high slope, wherein the danger of such a situation can be intensified if the vehicle is highly loaded.

### SUMMARY

It is therefore an object of the present disclosure to address the problems of the prior art. In particular, the intention is to find a brake system with electromechanical brake actuators which can hold a vehicle securely in any situation. In any case, an alternative to that which is known from the prior art is to be found.

According to the present disclosure, a brake system is provided as set forth in the present disclosure, drawings, and claims.

Accordingly, a brake system for carrying out a parking brake function of a vehicle is provided. The vehicle is preferably a commercial vehicle. The brake system includes a plurality of individually controllable brake actuators, which are preferably electromechanical brake actuators. Each of the brake actuators is assigned respectively to at least one wheel of the vehicle and configured to generate a braking force for braking the associated wheel as a function of a target braking force value assigned to the brake actuator.

Furthermore, the brake system includes a monitoring arrangement. The monitoring arrangement is configured to detect at least a first state and a second state of the vehicle.

In addition, the brake system includes a brake control device, which is configured to receive a parking brake request signal. Preferably, the parking brake request signal includes a request to lock a plurality or all of the wheels of the vehicle. A locking request corresponds, for example, to a request, preferably triggered by a driver, to hold the vehicle at a standstill by brake actuators, preferably on a plurality or all of the wheels of the vehicle, which are provided to implement a handbrake function, being controlled appropriately so that the vehicle is held at a standstill. Preferably, locking a plurality or all of the wheels to hold the vehicle at a standstill is accordingly requested by using the parking brake request signal. The monitoring arrangement is preferably a constituent part of the brake control device. However, according to an alternative, the monitoring arrangement can also be assigned to a further control device, wherein the brake system is then configured to transmit the detected first state or the detected second state to the brake control device.

The brake control device is further configured to control the brake actuators differently as a function of the detected first state or detected second state following the receipt of the brake request signal. In the case that the first state of the vehicle is detected by the monitoring arrangement, each of the brake actuators is respectively controlled with a value predetermined for the respective brake actuator as a target braking force value. If the second state is detected by the monitoring arrangement, at least one of the brake actuators is controlled with a target braking force value which corresponds to a sum of the value predetermined for the brake actuator and a compensation value component determined for the brake actuator.

Preferably, values for a parking brake function are accordingly predetermined for each of the brake actuators, which values are stored in a database, for example. In the case of the first state, the brake control device is configured to control the target braking force value of each brake actuator with the respective value predetermined for the brake actuator. Accordingly, a predetermined braking force is set. If the second state is detected, a plurality of the brake actuators can likewise be controlled with the predetermined value as a target braking force value but at least one of the brake actuators being actuated with a target braking force value which corresponds to the sum of the predetermined value and the compensation value component. Accordingly, at least one of the brake actuators is therefore controlled with a higher target braking force value than is specified by the predetermined value for the respective brake actuator. The compensation value component accordingly corresponds to a positive value.

Accordingly, the brake system is configured to monitor the state of the vehicle when carrying out a parking brake function and, depending on the state, if this corresponds to the first state, to supply the brake actuators with their predetermined value as a target braking force value in order to produce a corresponding braking force which is predetermined. This state can be, for example, a normal state of the vehicle. If all the defined conditions for a normal state during the parking of a vehicle and the activation of a parking brake function are accordingly fulfilled, for example, the first state can be assumed. If the state of the vehicle deviates from the normal state for which, for example, the values of the brake actuators are predetermined, this is detected as a second state of the vehicle and at least one of the brake actuators is controlled in such a way that the latter produces a higher braking force so that, despite the changed conditions, secure holding of the vehicle is made possible.

Thus, the brake actuators of a vehicle are controlled as a function of a state of the vehicle following the receipt of the parking brake request signal. The present disclosure is based on the finding that individual control of the brake actuators to hold the vehicle securely can be used under different conditions, wherein a state of the vehicle, which can also be called the vehicle state, must be detected to determine the conditions for the control.

According to a first embodiment, the monitoring arrangement is configured to monitor the function of each or a plurality of the brake actuators and to detect a fault-free function or a faulty function of each of the plurality of brake actuators. The monitoring arrangement is configured to detect the first state in the event of a detected fault-free function of each or all of the plurality of monitored brake actuators. In addition, the monitoring arrangement is configured to detect the second state in the event of a detected faulty function of at least one of the monitored brake actuators.

The monitoring arrangement thus monitors and checks whether each or a plurality of the plurality of brake actuators has a fault-free function or a faulty function. For this purpose, for example, sensors can be arranged on the brake actuators, in particular on those of the plurality of brake actuators which are to be monitored. A faulty function of a brake actuator can then also be identified by the monitoring arrangement or the brake control device having the monitoring arrangement, for example when the respective brake actuator reports the fault itself or the respective brake actuator provides no feedback or feedback of a fault in the form of data upon activation.

If all the brake actuators are identified as functioning, the brake actuators are controlled with the predetermined value as a target braking force value. If at least one of the brake actuators is identified as faulty, i.e. having a fault, then the second state is detected and it is accordingly assumed that the brake actuator cannot achieve its braking force assigned to it as a target braking force value via its predetermined value. In this case, at least a further one of the brake actuators is controlled with the sum of the value predetermined for it and the compensation value component, in order thus to exert an increased braking force and accordingly to replace the faulty or failed brake actuator.

Secure holding of a vehicle is thus made possible even in the event of a faulty, for example failed, brake actuator.

According to a further embodiment, the brake control device is configured to firstly determine a compensation braking force value in the case of a detected second state. The compensation braking force value is determined as a function of the predefined value of the brake actuator of the plurality that is faulty or as a function of the sum of the predefined values of each of the brake actuators of the plurality that is faulty. A faulty brake actuator corresponds to a brake actuator having a faulty function, and a fault-free brake actuator corresponds to a brake actuator having a fault-free function. In the case in which a brake actuator is therefore identified as a faulty brake actuator, the predefined value for this brake actuator is provided as a compensation braking force value or a compensation braking force value is determined as a function of the predefined value for this brake actuator. In the case of two or more brake actuators which are identified as faulty, a sum is formed which corresponds to the sum of the predefined values of the faulty brake actuators. This sum then corresponds to the compensation braking force value or a compensation braking force value is determined as a function of this sum.

For each of the brake actuators which have not been identified as faulty, preferably for each fault-free brake actuator, a respective compensation braking force value component is determined as a function of the compensation braking force value. Preferably, the sum of the compensation braking force value components corresponds to the compensation braking force value. Each of the fault-free brake actuators is then controlled with a target braking force value which corresponds to a sum of the value predefined for the brake actuator and the compensation value component determined for the respective brake actuator. Particularly preferably, the compensation value components are determined as equally large.

Depending on the type of failure, i.e. depending on how many brake actuators have failed, the braking force of the functioning, i.e. fault-free, brake actuators is therefore increased. Secure holding of the vehicle is thus maintained even in the event of failure of a plurality of brake actuators, on the other hand the braking force being increased only as far as is necessary in order to hold the vehicle securely. A secure hold is thus made possible while simultaneously taking correspondingly minimized wear into account.

According to a further embodiment, the monitoring arrangement for a plurality or each of the brake actuators has a respective sensor. The sensor is configured to detect a fault-free or faulty function of the brake actuator assigned to the sensor. The sensor is, for example, a force sensor, a pressure sensor, a displacement sensor or a sensor for determining a torque, i.e. a torque sensor. Alternatively or additionally, at least one electrical variable relating to activating the respective brake actuator is monitored in order, on the basis of a profile of the electrical variable, to detect a fault-free or faulty function of the brake actuator associated with the profile. Here, the electrical variable can, for example, comprise a voltage, a current or both.

A suitable possible way of monitoring the function of a brake actuator is thus created.

According to a further embodiment, the braking request signal includes a temporary or an ongoing locking request. In the case in which the parking brake request signal corresponds to a temporary locking request, the monitoring arrangement detects the first state. In the case that the parking brake request signal includes an ongoing locking request, the monitoring arrangement detects the second state.

A temporary locking request can, for example, correspond to a locking request when waiting at a traffic signal, wherein an ongoing locking request can correspond to the parking of a vehicle. The distinction between a temporary locking request and an ongoing locking request can be made, for example, by way of an input from a driver into an operating element. Alternatively or additionally, a distinction between a temporary locking request and an ongoing locking request can also be made automatically in that, for example, a parking brake request signal is automatically interpreted by the vehicle as a temporary locking request as long as a gear selector lever is in the drive position and/or the engine is running. By contrast, a parking brake request signal can be automatically interpreted as an ongoing locking request if no gear is selected, a gear selector lever is in the park position and/or an engine is switched off.

In the case of a second state detected by the monitoring arrangement, preferably a plurality or all of the plurality of brake actuators is each controlled with a target braking force value which corresponds to a sum of the value predetermined for the respective brake actuator and a compensation value component determined for the respective brake actuator.

Thus, for example when a vehicle stops only briefly, for example at a traffic signal, the temporary locking request signal, i.e. a parking brake request signal with a temporary locking request, is generated, so that the brake actuators are each controlled with their predetermined value. Here, it can be assumed that no cooling of the brakes will take place during the standstill, so the re-tightening or excessive tightening of the brakes is also not necessary. If, however, on the other hand, the vehicle is stopped for a longer time period, therefore the ongoing locking request is received as a parking brake request signal, then the brake actuators are each controlled with a value that is increased with respect to its predetermined value in order to produce a correspondingly increased braking force. In this case, cooling of the brakes during the stopping of the vehicle is preferably assumed, so that a correspondingly higher braking force is exerted, in order to have an adequate braking force for holding the vehicle available even after the cooling.

Preferably, the monitoring device and the brake control device are used to exert different braking forces with the brake actuators in different situations in which a parking brake is wished to lock the wheels.

According to a further embodiment, the predetermined values for the plurality of brake actuators are each predetermined by being retrieved from a memory, for example a memory of the brake control device, in which the respective value is predefined. Alternatively, the predetermined values for the plurality of brake actuators are each predetermined as a function of wear of the respective brake actuator, ageing of the respective brake actuator, a vehicle state or an environmental condition of the vehicle and preferably stored in the memory after a regular new predetermination.

Particularly preferably, the predetermination of values of the plurality of brake actuators is respectively carried out by retrieving a value predefined for the brake actuator from the memory and adapting this value as a function of at least one from wear of the respective brake actuator, ageing of the respective brake actuator, a vehicle state or an environmental condition of the vehicle.

An environmental condition includes, for example, an ambient temperature. A vehicle state corresponds to or includes, for example, a vehicle weight such as, for example, a total vehicle weight, or a total weight of a combination including the vehicle and a vehicle trailer. A wear of the respective brake actuator corresponds, for example, to wear of the brake pads. A gradient or a terrain can be taken into account either as an environmental condition or as a vehicle state. Wear of the respective brake actuator can also correspond to a state of wear or a state of ageing of the brake actuator itself which, for example, can be determined from mechanical load monitoring from the respective sensor.

According to a further embodiment, the brake control device is configured to determine the compensation value component for one or more of the plurality of brake actuators as a function of wear of the brake actuator, ageing of the brake actuator, a vehicle state or an environmental condition of the vehicle. The compensation value component accordingly likewise depends on the aforementioned factors.

Additionally or alternatively, a ratio of the compensation value components to one another can be determined as a function of wear of each or a plurality of the plurality of brake actuators, ageing of each or a plurality of the plurality of brake actuators, a vehicle state or an environmental condition of the vehicle. Accordingly, therefore, compensation value components for different brake actuators can also be differently large or high so that, for example, more highly worn brake actuators will be given a comparatively lower compensation value component than brake actuators that are not so highly worn. Uniform wear of the brake actuators is thus achieved.

According to a further embodiment, the brake control device is configured to determine wear, ageing or both of each or a plurality of the plurality of brake actuators. Here, wear or ageing is preferably determined by monitoring the actuation of the respective brake actuator. Accordingly, for each of the brake actuators, which braking force is used and how frequently a brake actuator is used are preferably recorded. In this way, wear or ageing can also be at least estimated without additional sensors.

According to a further embodiment, the brake system includes a display. In the case of a second state detected by the monitoring arrangement, the brake system is configured to output the second state for a driver by using the display. For example, in the case of a faulty function of at least one of the brake actuators, a display of the fault is thus provided for the driver and the driver is informed about this fault in order, for example, to correct the fault or have it corrected as quickly as possible.

According to a further embodiment, following the receipt of the parking brake request signal and in the case of a second state detected by the monitoring arrangement, the brake control device is configured to actuate a lift axle of the vehicle in order to lower the lift axle. Furthermore, following the receipt of the parking brake request signal, the brake control device is configured to control at least one brake actuator of at least one of the wheels of the lift axle with a target braking force value. Here, the brake actuator of the lift axle is preferably controlled with a target braking force value which corresponds to a sum of the value predetermined for the brake actuator of the lift axle and a compensation value component determined for the brake actuator of the lift axle. According to a preferred refinement of the embodiment, the brake actuator of the lift axle is controlled only with the compensation value as a target braking force value or a compensation value component as a target braking force value, wherein, particularly preferably, the remaining brake actuators, in particular apart from the faulty brake actuator, are each controlled with their predetermined value as a target braking force value.

In particular in the case of a faulty brake actuator, by way of which a second state is identified, the lift axle is thus additionally lowered, even if this has not been lowered, and is used to provide an additional braking force for compensation of the faulty, in particular failed, brake actuator.

According to a further embodiment, the brake control device is configured to determine minimum target braking force values following the receipt of the parking brake request signal. This is done by activating a plurality or all of the brake actuators each with the target braking force values determined in the brake control device, i.e. preferably the predetermined target braking force values. The brake system is therefore configured to control each brake actuator with a target braking force value. Furthermore, the brake control device is configured in such a way that, after the control, it reduces a plurality or all of the target braking force values until a vehicle movement is detected by the brake control device. A vehicle movement can be detected, for example, by wheel rotational speed sensors of the vehicle. In addition, the brake control device is configured to increase all of the target braking force values by a safety margin which, for example, is predefined, after a vehicle movement has been detected. The target braking force values that are increased by the safety margin correspond to the minimum target braking force value.

These steps, which can be carried out by the brake control device, can be carried out either when a first state is identified or else when a second state is identified, wherein, during the first control of a plurality or all of the brake actuators, before the reduction of the brake actuators, each brake actuator is preferably controlled with the predetermined value or with the predetermined value plus the compensation value component.

Furthermore, the brake system is preferably designed to check the minimum target braking force value. To this end, the brake control device is configured to drive the vehicle temporarily and to check whether a vehicle movement results from the driving. The steps which the brake control device carries out here can also be carried out as method steps according to an exemplary embodiment of the method according to the present disclosure. By determining the minimum target braking force values, a check is made as to whether the determined target braking force values are sufficient to hold the vehicle securely and, if appropriate, are even reduced in order to reduce wear on the brakes.

According to a further embodiment, the brake control device is configured to lock all the brake actuators mechanically following the control of the brake actuators with the respective target braking force value or minimum target braking force value, in order to prevent any movement of the respective brake actuator. Accordingly, the brake system has a locking mechanism for one or more brake actuators, which ensures that the respective brake actuator does not move when de-energized and thus, for example, reduces a braking force.

Furthermore, the present disclosure relates to a vehicle having a brake system as claimed in one of the aforementioned embodiments. The vehicle particularly preferably includes a lever or switch for the activation and deactivation of a parking brake function. Preferably, in the case of an activated parking brake function, i.e. following the activation of the lever or switch for activating a parking brake, a parking brake request signal is generated and transmitted to a brake control device from the lever or switch.

In addition, the present disclosure relates to a method for carrying out a parking brake function of a brake system according to an embodiment or for operating a vehicle according to the present disclosure.

According to one embodiment, the method includes receiving a parking brake request signal by using a brake control device of the brake system. In addition, a state of the vehicle is detected by using a monitoring arrangement and brake actuators of the vehicle are controlled with target braking force values, depending on the detected state of the vehicle.

### BRIEF DESCRIPTION OF THE DRAWINGS

Further embodiments can be gathered from the exemplary embodiments explained in more detail in the figures, in which:

FIG. 1 shows a vehicle according to an exemplary embodiment, and

FIG. 2 shows the steps of a method according to an exemplary embodiment.

### DETAILED DESCRIPTION

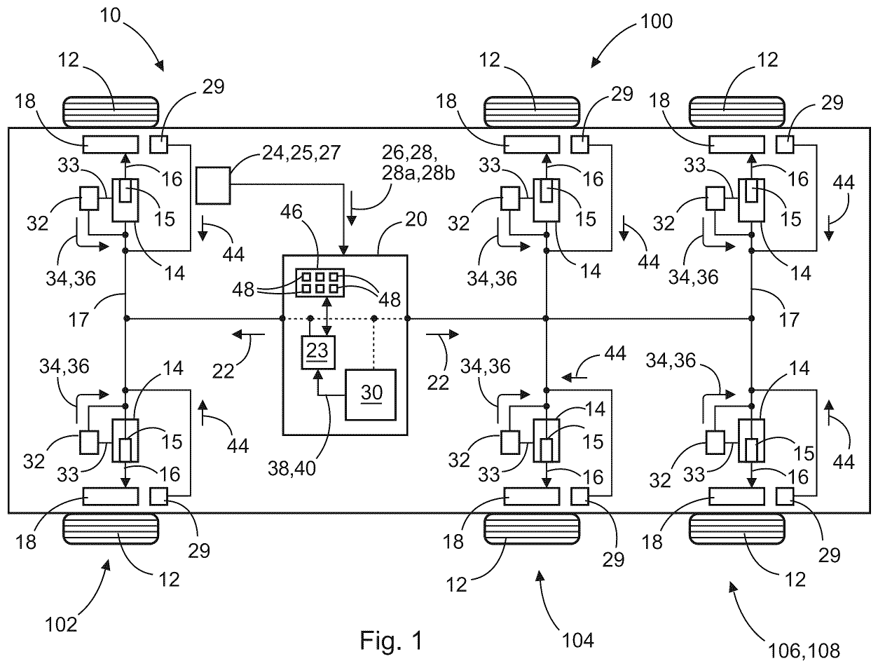

FIG. 1 shows a vehicle 100 having a brake system 10 for carrying out a parking brake function 82 of the vehicle 100. The vehicle 100 includes three axles, 102, 104, 106, wherein the axle 106 corresponds to a lift axle 108. The vehicle 100 includes a brake actuator 14 on each of its wheels 12. The brake actuators 14 are each configured to carry out a mechanical movement in order in this way to exert a braking force 16 on a brake device 18, illustrated by way of example. Each of the brake actuators 14 has, for example, an interface module 15 which, in addition to the mechanical part that is designed to generate the braking force 16, permits communication with a brake control device 20 via a data bus 17. The brake device 18 preferably includes a combination, not illustrated in detail in FIG. 1, of a brake disk and a brake pad, wherein the brake pad is pressed against the brake disk by the braking force 16.

Also illustrated in FIG. 1 is the brake control device 20, which is connected to each of the brake actuators 14 via the data bus 17 in order to control each of the brake actuators 14 respectively individually by using a target braking force value 22. The braking force 16 is set as a function of the target braking force value 22 which is predefined to a brake actuator 14 by the brake control device 20. The vehicle 100 also has an operating element 24. The operating element 24 is preferably a lever 25 or a switch 27. The operating element 24 can be operated by a driver of the vehicle 100 and is used to transmit a parking brake request signal 26 to the brake control device 20 as a function of an input into the operating element 24. The parking brake request signal 26 preferably corresponds to a locking request 28. The locking request 28 preferably corresponds to a temporary locking request 28a or an ongoing locking request 28b. The locking request 28 corresponds to a request by a driver that a plurality or all of the wheels 12 of the vehicle 100 are to stop completely, i.e. each or a plurality of the wheels 12 are to be stopped by using the brake actuators 14 such that a rotational movement of the wheels 12 is completely prevented.

Furthermore, the vehicle 100 includes a monitoring arrangement 30, which is a constituent part of the brake control device 20. The monitoring arrangement 30 is connected to sensors 32 on each of the brake actuators 14 in order to check whether each sensor 32 respectively has a fault-free function 34 or a faulty function 36. The monitoring arrangement 30 thus detects for each of the brake actuators 14 whether the latter is operating without fault or has a fault. This is done, for example, by detecting an electrical variable 33 of the respective brake actuator 14. In a corresponding way, a fault-free function 34 or a faulty function 36 of each of the sensors 32 is notified to the monitoring arrangement 30. Depending on the sensor signals, the monitoring arrangement 30 then determines whether the vehicle 100 is in a first state 38 or a second state 40. The first state 38 corresponds to a state in which all the brake actuators 14 have a fault-free function 34. The second state 40 corresponds to a state of the vehicle 100 in which at least one of the brake actuators 14 has a faulty function 36. Depending on the state 38, 40 detected by the monitoring arrangement 30, the target braking force value 22 for each of the brake actuators 14 is then determined by using the brake control device 20, in particular a control logic unit 23, and the brake actuators 14 are each controlled with their target braking force value 22.

In addition, each of the wheels 12 is assigned a wheel rotational speed sensor 29, which is connected to the data bus 17 and, via this data link, sends a wheel rotational speed 44 to the brake control device 20 and/or the monitoring arrangement 30. The brake control device 20 preferably also includes a memory 46, in which predetermined values 48 for each of the brake actuators 14 are respectively stored, which values are intended to be used as target braking force values 22 for the respective brake actuator 14, for example upon the receipt of a braking request signal.

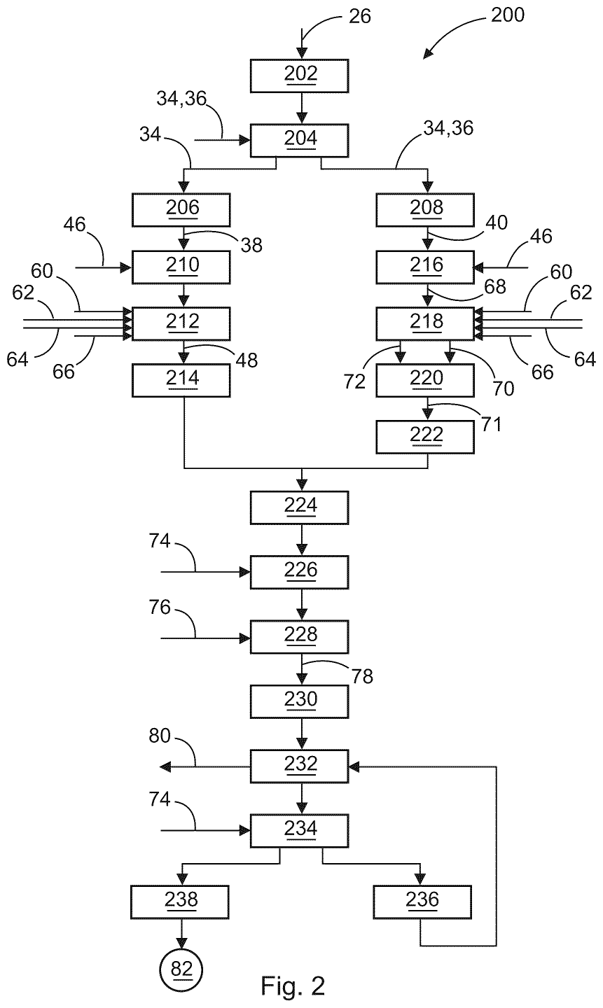

FIG. 2 shows the steps of a method 200 according to a first exemplary embodiment. In step 202, a parking brake request signal 26 is received from an operating element 24. In step 204, by receiving signals from sensors 32 for each of the brake actuators 14, a check is made as to whether the latter has a fault-free function 34 or a faulty function 36. In the case in which all the brake actuators 14 have a fault-free function 34, in step 206 a first state 38 of the vehicle 100 is detected. If one of the brake actuators 14 is faulty, i.e. has a faulty function 36, in step 208 a second state 40 of the vehicle 100 is detected by the monitoring arrangement 30.

In the case that the first state 38 has been detected, in step 210 a value 48 that is predetermined for the respective brake actuator 14 is retrieved from a memory 46 for each of the brake actuators 14. In step 212, wear 60 for each of the brake actuators 14, ageing 62 for each of the brake actuators 14, a vehicle state 64, and at least one environmental condition 66 is retrieved from the memory 46 or further sensors 32 of the vehicle 100, and the predefined value 48 is adapted as a function of the wear 60, the ageing 62, the vehicle state 64 and/or the environmental condition 66. Then, in step 214, each of the brake actuators 14 is controlled with the value 48 thus determined as a target braking force value 22.

If, by contrast, a second state 40 is detected in step 208, in step 216 firstly a compensation braking force value 68 is determined as a function of the predetermined value 48 of the plurality of brake actuators 14 that are faulty or as a function of the sum of the predetermined values 48 of each of the plurality of brake actuators 14 that is faulty. The predetermined value or values are preferably calculated in step 216 as in step 210 and 212 or correspond to a predetermined value which is stored in the memory 46.

Furthermore, in step 218, at least one compensation braking force value component 70 is determined as a function of the compensation braking force value 68. This compensation braking force value component 70 is additionally determined for each of the fault-free functioning brake actuators 14 as a function of a wear 60 of the respective brake actuator 14, ageing 62 of the respective brake actuator 14, a vehicle state 64, and/or an environmental condition 66 of the vehicle 100. Here, a ratio 72 of the compensation value components 70 is also determined as a function of the wear 60, the ageing 62, a vehicle state 64 and an environmental condition 66. In step 220, for each of the brake actuators 14 with a fault-free function 34, a sum 71 is then determined which corresponds to the sum 71 of the value 48 predetermined for the brake actuator 14 and a compensation value component 70 determined for the brake actuator 14. The predetermined values of the functioning brake actuators 14 are preferably likewise determined as in step 210 and 212. Each of the brake actuators 14 is then controlled in step 222 with the sum 71 as a target braking force value 22.

Once all the brake actuators 14 have been controlled with their determined target braking force value 22 in step 222 or 214, in step 224 one or more of the target braking force values 22 is reduced until, in step 226, a vehicle movement 74 is detected by the brake control device 20. In step 228, all of the target braking force values 22 which have previously been reduced are then increased by a safety margin 76, wherein the target braking force value 22 resulting therefrom corresponds to a minimum target braking force value 78, with which the respective brake actuator 14 is then controlled in step 230. In step 232, the vehicle 100 is then driven temporarily 80 and, in step 234, a check is made as to whether a vehicle movement 74 results from the driving. In the case that a vehicle movement 74 takes place, in step 236 the target braking force values 22 are increased further and, after that, step 232 is carried out again. In the case that no vehicle movement 74 results, the brake actuators 14 are locked in step 238, so that a parking brake function 82 is carried out.

### REFERENCE SIGNS (PART OF THE DESCRIPTION)

10 Brake system
12 Wheels
14 Brake actuator
15 Interface module
16 Braking force
17 Data bus
18 Brake device
20 Brake control device
22 Target braking force value
23 Control logic unit
24 Operating element
25 Lever
26 Parking brake request signal
27 Switch
28 Locking request
28a Temporary locking request
28b Ongoing locking request
29 Wheel rotational speed sensor
30 Monitoring arrangement
32 Sensors
33 Variable
34 Fault-free function
36 Faulty function
38 First state
40 Second state
44 Wheel rotational speed
46 Memory
48 Values
60 Wear
62 Ageing
64 Vehicle state
66 Environmental condition
68 Compensation braking force value
70 Compensation braking force value component
72 Ratio
71 Sum
74 Vehicle movement
76 Safety margin
78 Minimum target braking force value
80 Temporary driving
82 Parking brake function
100 Vehicle
102 Axle
104 Axle
106 Axle
108 Lift axle
200 Method
202 Receive parking brake request signal
204 Check function by receiving signals
206 Detect first state
208 Detect second state
210 Retrieve value
212 Retrieve wear, ageing, vehicle state, environmental condition and adapt value
214 Control brake actuators with target braking force value
216 Determine compensation braking force value
218 Determine compensation braking force value component
220 Determine sum
222 Control brake actuators with target braking force value
224 Reduce target braking force values
226 Detect vehicle movement
228 Increase target braking force values by safety margin
230 Control the brake actuators
232 Temporarily drive the vehicle
234 Check whether vehicle movement takes place
236 Increase target braking force values
238 Lock brake actuators

What is claimed is:

1. A brake system (10) for carrying out a parking brake function (82) of a vehicle (100), comprising:
a plurality of individually controllable brake actuators (14), wherein each of the brake actuators (14) is assigned respectively to at least one associated wheel (12) of the vehicle (100) and generates a braking force (16) for braking the associated wheel (12) as a function of a target braking force value (22) assigned to the brake actuator (14),
a monitoring arrangement (30) that detects a least a first state (38) and a second state (40) of the vehicle,
a brake control device (20) that receives a parking brake request signal (26) indicating a locking request (28) of a plurality or all of the wheels (12) of the vehicle (100) and, following the receipt of the parking brake request signal (26),
a) in the case of a first state (38) detected by the monitoring arrangement (30), controls each of the brake actuators (14) respectively with a value (48) predetermined for the respective brake actuator (14) as a target braking force value (22), and
b) in the case of a second state (40) detected by the monitoring arrangement (30), controls at least one of the brake actuators (14) with a target braking force value (22) that corresponds to a sum (72) of the value (48) predetermined for the at least one brake actuator (14) being controlled in the case of the second state and a compensation value component (70) determined for the at least one brake actuator (14) being controlled in the case of the second state.

2. The brake system (10) as claimed in claim 1, wherein the monitoring arrangement (30) monitors each or a plurality of the brake actuators (14) and detects a fault-free function (34) or a faulty function (36) of the monitored brake actuators (14), wherein the monitoring arrangement (30) detects the first state (38) in the event of a detected fault-free function (34) of all of the plurality of monitored brake actuators (14), and detects the second state (40) in the event of a detected faulty function (36) of at least one of the plurality of monitored brake actuators (14).

3. The brake system (10) as claimed in claim 2, wherein in the case of a detected second state (40), the brake control device (20)
determines a compensation braking force value (68) as a function of the predefined value of the brake actuator with a faulty function (36) of the plurality of brake actuators (14) or as a function of the sum of the predefined values of each of the brake actuators with a faulty function (36) of the plurality of brake actuators (14),
for each of the brake actuators with a fault-free function (34) of the plurality of brake actuators (14), determines a respective compensation braking force value component (70) as a function of the compensation braking force value (68), and,
controls each of the brake actuators with a fault-free function (34) of the plurality of brake actuators (14) respectively with a target braking force value (22) that corresponds to a sum of the value predefined for the brake actuator (14) and the compensation value component (70) determined for the brake actuator (14).

4. The brake system (10) as claimed in claim 3, wherein the monitoring arrangement (30) for a plurality or each of the brake actuators (14) respectively
comprises a sensor (32) that, by using the sensor (32), detects a fault-free function (34) or a faulty function (36) of the brake actuator (14) assigned to the sensor (32) or
monitors an electrical variable (33) for controlling the respective brake actuator (14) that, on the basis of a profile of the electrical variable (33), detects a fault-free function (34) or a faulty function (36) of the brake actuator (14) associated with the profile.

5. The brake system (10) as claimed in claim 1,
wherein the parking brake request signal (26) comprises a temporary or ongoing locking request (28b) and the monitoring arrangement (30) receives the parking brake request signal (26) and, in the case of a temporary locking request (28a), detects the first state (38) and, in the case of an ongoing locking request (28b), detects the second state (40),
wherein, following the receipt of the parking brake request signal (26), the brake control device (20), in the case of a second state (40) detected by the monitoring arrangement (30), controls a plurality or all of the plurality of brake actuators (14) with a respective target braking force value (22) that corresponds to a sum of the value (48) predetermined for the respective brake actuator (14) and a compensation value component (70) determined for the respective brake actuator (14).

6. The brake system (10) as claimed in claim 1, wherein the predetermined value (48) for the plurality of brake actuators (14) is each predetermined by being retrieved from a memory (46) in which the respective value (48) is predefined.

7. The brake system (10) as claimed in claim 1, wherein the brake control device (20) determines the compensation value component (70) for one or more of the plurality of brake actuators (14) as a function of wear (60) of the brake actuator (14), ageing (62) of the brake actuator (14), a vehicle state (64), or an environmental condition (66) of the vehicle (100).

8. The brake system (10) as claimed in claim 7, wherein the brake control device (20) determines wear (60) or ageing (62) of each or a plurality of the plurality of brake actuators (14) by monitoring the activations of the respective brake actuator (14).

9. The brake system (10) as claimed in claim 1, wherein the brake system (10) comprises a display and, in the case of a second state (40) detected by the monitoring arrangement (30), displays the second state (40) for a driver by using the display.

10. The brake system (10) as claimed in claim 1, wherein the brake control device (20), following the receipt of the parking brake request signal (26) in the case of a second state (40) detected by the monitoring arrangement (30), controls a lift axle (108) of the vehicle (100) in order to lower the lift axle (108) and controls at least one brake actuator (14) of at least one of the wheels of the lift axle (108) with a target braking force value (22) that corresponds to a sum of the value predetermined for the brake actuator (14) of the lift axle (108) and a compensation value component (70) determined for the brake actuator (14) of the lift axle (108).

11. The brake system (10) as claimed in claim 1, wherein the brake control device (20) determines determine minimum target braking force values (22) following the receipt of the parking brake request signal (26), by:
controlling a plurality or all of the brake actuators (14) each with the target braking force value (22) determined in the brake control device (20),
reducing a plurality or all of the target braking force values (22) until a vehicle movement (74) is detected by the brake control device (20),
increasing all the target braking force values (22) by a safety margin (76), wherein the target braking force values (22) increased by the safety margin (76) correspond to the minimum target braking force values (22),
checking the minimum target braking force value (22) by temporarily driving (80) the vehicle (100) and checking whether a vehicle movement (74) results from the driving (80).

12. The brake system (10) as claimed in claim 11, wherein the brake control device (20) locks all of the brake actuators (14) mechanically following the controlling of the brake actuators (14) with the respective target braking force value (22) or the minimum target braking force value (22), in order to prevent any movement of the respective brake actuator (14).

13. A vehicle (100) having a brake system (10) as claimed in claim 1 and a lever (25) or switch (27) for activating and deactivating a parking brake function (82), wherein in the case of an activation of a parking brake function (82), a parking brake request signal (26) is generated and transmitted to a brake control device (20) from the lever (25) or switch (27).

14. A method (200) for carrying out a parking brake function (82) of a brake system (10) as claimed in claim 1 by operating the brake control device (20).

15. The method (200) as claimed in claim 14, wherein the method (200) comprises:
receiving the parking brake request signal (26) by using the brake control device (20) of the brake system (10),
detecting the first or second state (38, 40) of the vehicle (100) by using the monitoring arrangement (30), and
controlling brake actuators (14) of the vehicle (100) with target braking force values (22), which are determined as a function of the detected state (38, 40) of the vehicle (100).

16. The brake system (10) as claimed in claim 2, wherein the monitoring arrangement (30) for a plurality or each of the brake actuators (14) respectively
comprises a sensor (32) that, by using the sensor (32), detects a fault-free function (34) or a faulty function (36) of the brake actuator (14) assigned to the sensor (32) or
monitors an electrical variable (33) for controlling the respective brake actuator (14) that, on the basis of a profile of the electrical variable (33), detects a fault-free function (34) or a faulty function (36) of the brake actuator (14) associated with the profile.

17. The brake system (10) as claimed in claim 1, wherein the predetermined value (48) for the plurality of brake actuators (14) is each predetermined as a function of wear (60) of the respective brake actuator (14), ageing (62) of the respective brake actuator (14), a vehicle state (64), or an environmental condition (66) of the vehicle (100).

18. The brake system (10) as claimed in claim 17, wherein the brake control device (20) determines wear (60) or ageing (62) of each or a plurality of the plurality of brake actuators (14) by monitoring the activations of the respective brake actuator (14).

19. The brake system (10) as claimed in claim 1, wherein the brake control device (20) determines a ratio (72) of the compensation value components (70) relative to one another as a function of wear (60) of a plurality or each of the plurality of brake actuators (14), ageing (62) of a plurality or each of the plurality of brake actuators (14), a vehicle state (64) or an environmental condition (66) of the vehicle (100).
